(19) United States
(12) Patent Application Publication
(10) Pub. No.: US 2008/0223730 A1
(43) Pub. Date: Sep. 18, 2008

(54) ELECTROCHEMICAL TREATMENT OF SOLUTIONS CONTAINING HEXAVALENT CHROMIUM

(75) Inventor: Paolo Rossi, Brugherio(MI) (IT)

Correspondence Address: ESCHWEILER & ASSOCIATES, LLC;NATIONAL CITY BANK BUILDING, 629 EUCLID AVE., SUITE 1000, CLEVELAND, OH, 44114, US

(73) Assignee: Industrie De Nora S. p.A., Milan (IT)

(21) Appl. No.: 12/129,336

(22) Filed: May 29, 2008

Related U.S. Application Data
(63) Continuation of application No. PCT/EP2006/069080, filed on Nov. 29, 2006.

(30) Foreign Application Priority Data
Nov. 30, 2005 (IT) MI2005A002297

(51) Int. Cl. C02F 1/461

(52) U.S. Cl. 205/742

(57) ABSTRACT

There is disclosed a process of electrochemical reduction, optionally coupled to a final stage of chemical finishing, of solutions containing hexavalent chromium. The electrochemical reduction is carried out making use of a cell of cylindrical geometry with tangential solution inlet and outlet, which establishes and maintains a spiral flow across the whole electrolysis bulk, achieving effective mass transport conditions.

### CROSS-REFERENCE TO RELATED APPLICATION

This application is a continuation of PCT/EP2006/069080, filed Nov. 29, 2006, that claims the benefit of the priority date of Italian Patent Application No. M12005A002297, filed on Nov. 30, 2005, the contents of which are herein incorporated by reference in their entirety.

### BACKGROUND

Hexavalent chromium, in the form of chromic acid and derivative salts thereof, has a long record of use in industrial applications, for instance in the tanning, water treatment and galvanic industry. Such applications, however, are characterised by increasing difficulties associated with the high toxicity.

Sodium chromates, for instance, have been employed at the tens of ppm level as anti-corrosion agents in cooling waters of industrial plants with tower circuits. The circuits are characterised by two types of releases, the first consisting of the liquid purges normally effected in order to maintain constant levels of salinity in the circulating water, and the second consisting of the micro-droplet drag in the tower airflow. While the former are made harmless for instance by addition of chemical reducing agents followed by filtration of the precipitated trivalent chromium, the latter escape to any reasonable possibility of treatment and constitute therefore a source of heavy pollution for the surrounding environment. For this reason, chromates were long abandoned in the case of tower cooling circuits, and their use has been limited to the sealed cooling systems characterised by the optional presence of liquid-only purges.

The use of hexavalent chromium in the galvanic industry, in the form of chromium anhydride and sulphuric acid solution, particularly for hard chrome plating for mechanical applications, is still practised. The chrome plating plants release wastes mainly consisting of rinse waters for the finished pieces and of exhausted baths, generally containing sulphuric acid and chromates, where chromates include the family of ions generated by the complex polymerisation equilibria established as a function of pH. These solutions also contain the trivalent chromium ion, which is in fact a by-product of the chromium metal deposition reaction, and other metal ions, particularly iron ions released by the pieces to be plated. The presence of trivalent chromium negatively affects both the chrome plating efficiency and the quality of the final product, therefore the accumulation thereof is permitted up to certain critical levels beyond which a solution purging is precisely required. These solutions must be treated to make them compliant with the regulations for direct or consortium sewage discharge, in accordance whereof the allowed concentrations of hexavalent chromium are on the order of fractions of parts per million (ppm), typically 0.05-0.25 ppm. The adopted processes are, in the majority of cases, of the chemical type and provide the addition of reducing agents such as sodium sulphite or disulphate, ferrous sulphate, dispersed metallic iron particles, coupled to an acidity neutralisation with final filtration of the precipitated hydroxides. Among the cited reducing agents, sodium sulphite (or metabisulphite) is the most common. Sodium sulphite, Na₂SO₃, is capable of decreasing the concentration of hexavalent chromium (chromate) below the limits imposed by the discharge regulations according to the reaction:

2H₂CrO₄+3Na₂SO₃+3H₂SO₄→Cr₂(SO₄)₃+3Na₂SO₄+5H₂O

The reaction indicates that the use of sodium sulphite determines a strong increase in the overall salt concentration, such that it creates difficulties in the final disposal or in the possible trivalent chromium recovery by chromium sulphate crystallisation.

In the technical literature, several kinds of electrochemical processes are also disclosed. These are distinguished between two types characterised, respectively, by direct reduction of hexavalent chromium at the electrolysis cell cathode and by indirect reduction by means of a reductant generated within the cell itself. The former kind of process is characterised by the overall reaction:

2H₂CrO₄+3H₂SO₄→Cr₂(SO₄)₃+ 3/2O₂+5H₂O

In all embodiments it is invariably provided that the cathode has a high surface area, for instance consisting of a conductive carbon particle bed across which the solution to be treated is conveyed. The object of this complex electrode structure is to achieve a high mass transport capacity even at low final hexavalent chromium concentrations so as to keep the cell size within reasonable limits. The anode may have a structure equivalent to that of the cathode. Carbon, no matter how subject to corrosion caused by oxygen anodic evolution, is capable of preventing chromium reoxidation from trivalent to hexavalent. This process is not satisfactory from a practical standpoint due to the complexity of manufacturing big size electrodes consisting of particle beds and for the need of a periodic intervention to reconstruct the corroded anode.

The second type of process disclosed in the technical literature provides that the anode of the electrolysis cell is an iron anode releasing ferrous ions, or a tin anode releasing stannous ions, both ions being capable of reacting with hexavalent chromium. Hence, the reduction of hexavalent chromium is not carried out directly on the cathode surface, being instead indirectly performed in a homogeneous phase in the bulk solution. The indirect process overcomes the problems associated with the mass transport, but is not practical due to the need for a periodic intervention when the anode is consumed beyond a certain limit.

It would be desirable to provide an electrochemical method for reducing hexavalent chromium (chromate) characterised by the use of an electrolysis cell of simplified structure and free of cathodes consisting of particle beds as in the electrochemical processes of the prior art.

### SUMMARY OF THE INVENTION

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

As provided herein, the invention comprises an electrochemical process which allows performance of the cathodic reduction of hexavalent chromium contained in a raw solution to trivalent chromium in an electrolysis cell free of separator and equipped with a stainless steel cathode and an anode suitable for oxygen evolution. The process establishes and maintains high turbulence conditions across the whole bulk at low solution flow-rates, preferably not exceeding 10 m³/h per m² of cathodic surface.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### BRIEF DESCRIPTION OF THE DRAWINGS

The invention will be now described with the help of the following figures:

FIG. 1 illustrates a circuit comprising an electrolysis cell of vertical cylindrical geometry suitable for a first embodiment of the invention.

FIG. 2 illustrates a circuit comprising an electrolysis cell of vertical cylindrical geometry suitable for a second embodiment of the invention.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details.

One or more implementations of the invention are hereinafter illustrated and described. However, it will be appreciated by those skilled in the art that the invention is not limited to the exemplary implementations illustrated and described hereinafter.

In one embodiment, the process is carried out in a cell having a cylindrical geometry with the cathode constituting the external wall, and with the anode installed as a coaxial anode. The cell is provided with tangential inlet and outlet for the raw and the reduced solution, respectively.

The process is carried out making use of an anode suitable for evolving oxygen at potentials at which the trivalent chromium reoxidation to hexavalent chromium does not occur at all, or takes place at a rate not significantly interfering with the cathodic reduction. In one embodiment, the hexavalent chromium cathodic reduction is carried out with simultaneous formation of trivalent and metallic chromium.

In one embodiment, the anode suitable for oxygen evolution is provided with a porous, catalytically inert external layer capable of acting as a diffusive barrier.

In one embodiment, the cathodic reduction is protracted until obtaining a residual hexavalent chromium concentration complying with the norms applicable to the discharge of liquid wastes of industrial origin. The treated solution may then be neutralised, precipitating and separating by filtration the trivalent chromium hydroxide, or it may be concentrated by evaporation, separating the trivalent chromium as chromium sulphate by crystallisation.

In an alternative embodiment, the cathodic reduction is conversely arrested at a final hexavalent chromium concentration higher than the limits provided by the applicable norms of liquid wastes of industrial origin, and the resulting solution is subjected to a final treatment with a chemical reductant making it compliant with said norms, for example, sodium sulphite or metabisulphite.

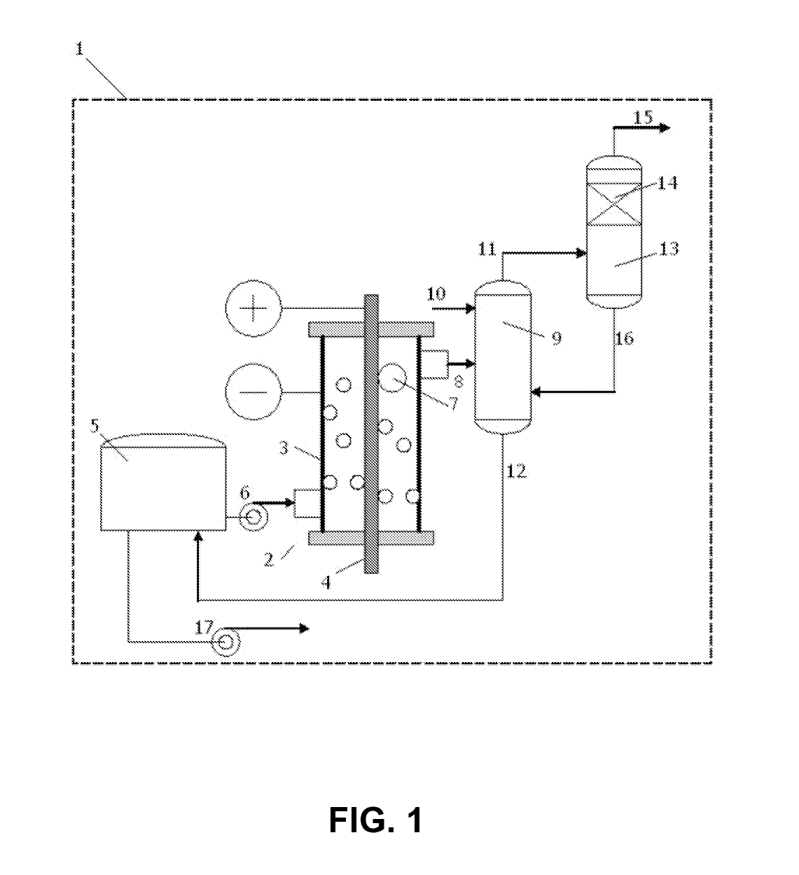

In FIG. 1 there is illustrated, without any reference to the relative dimensions, the main components of the circuit used in the process of complete reduction of hexavalent chromium exclusively by electrochemical way. In particular, (1) indicates the overall circuit; (2) the electrolysis cell equipped with the cylindrical cathode (3) and with the coaxial central anode (4); (5) the storage vessel of the raw solution containing the hexavalent chromium to be reduced to trivalent chromium; (6) the pump for feeding the raw solution to the cell; (7) the hydrogen and oxygen gas, respectively, evolved at the cell cathode and anode; (8) the biphasic mixture comprising the electrolysed solution and the gases; (9) the gas-solution separator; (10) the diluting air required to keep the hydrogen concentration outside the flammability threshold; (11) the diluting air containing the hydrogen and the oxygen separated from the solution; (12) the electrolysed solution recycle to the storage vessel maintained until reaching the desired final concentration of hexavalent chromium; (13) the separator for the water micro-droplets carried by the diluting air, equipped with a demister (14); (15) the vent for the diluting air containing hydrogen and oxygen but exempt from dragged solution; (16) the recycle of the liquid phase formed by the separated micro-droplets; and (17) the pump started up at the end of the electrolysis to transfer the reduced solution contained in the storage vessel to the final chromium sulphate neutralisation and filtration, or evaporation and crystallisation treatment (not shown in the figure).

The cell is equipped with a lower and an upper nozzle, both oriented horizontally and tangentially, respectively, for feeding the raw solution containing the hexavalent chromium to be reduced and for extracting the mixture consisting of gases (hydrogen and oxygen produced in the cell) and of electrolysed solution depleted of hexavalent chromium. With this nozzle arrangement, the solution flow assumes a spiral configuration which is substantially maintained along the whole body of the cell. Such a flow ensures an elevated mass transport with a much simpler and easily manufactured construction than that of the prior art based on the use of cathodes consisting of particle beds. The cell design is further simplified by the fact that the process does not require the presence of a separator, for instance of a porous diaphragm or ion-conducting membrane, to separate the cathode from the anode.

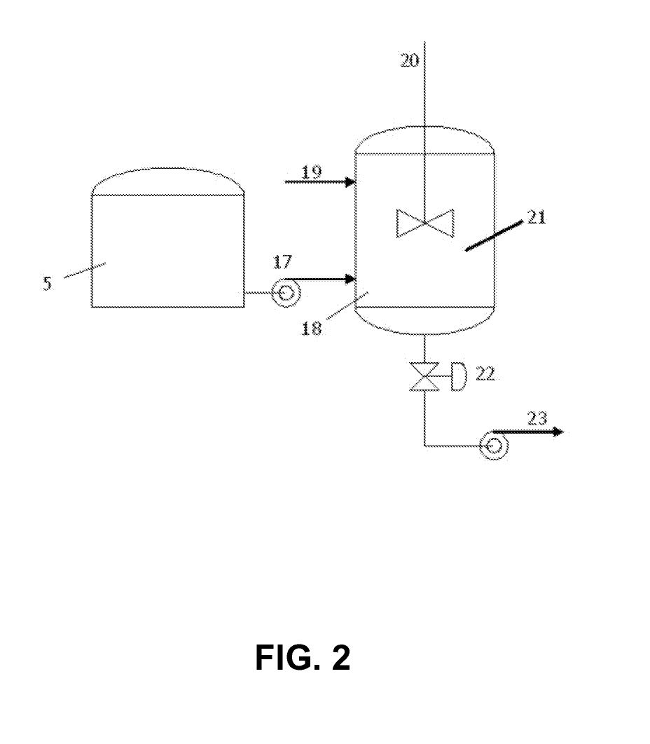

FIG. 2 illustrates a circuit utilised in a second embodiment of the process of the invention, wherein (5) identifies, as in FIG. 1, the storage vessel of the reduced solution obtained by arresting the electrolysis in correspondence of higher residual hexavalent chromium concentrations than allowed for discharging to the external environment; (17), as in FIG. 1, the pump for circulating the reduced solution, to be switched on only at the end of the electrolysis; (18) a reactor wherein the reduced solution sent by pump (17) is reacted with a chemical reductant (19) in order to obtain the final abatement of the hexavalent chromium concentration; (20) a stirrer which ensures the mixing of the reduced solution with the reductant; (21) a potentiometric element for measuring the solution redox potential as disclosed in the known electroanalytical techniques; (22) a valve to be opened at the end of the chemical reduction procedure; and (23) the pump directed to transfer the completely reduced solution to the final chromium sulphate neutralisation and filtration or evaporation and crystallisation treatment.

### EXAMPLE 1

The circuit of FIG. 1 was used for testing a first embodiment of the process of the invention. Cell (1) consisted of a cylindrical body of AISI 316L-type stainless steel connected to the negative pole of a rectifier and acting as the cathode, with an cylindrical anode installed centrally and coaxially to the cathode. On the cathode, the reduction of hexavalent to trivalent chromium took place, with simultaneous marginal deposition of metallic chromium and hydrogen evolution. The anodic reaction consisted of oxygen evolution.

The circuit of FIG. 1 and the above described cell were employed to perform the treatment of a raw solution coming from a chromium-plating plant and containing 125 g/l hexavalent chromium, 2.6 g/l trivalent chromium, 5 g/l ferrous ion, and free sulphuric acid in such a concentration as to establish a pH of 1.1.

The solution was subdivided into five equivalent 5 litre lots employed in the tests described hereafter.

The employed cell comprised a vertical cylindrical cathode of AISI 316L-type stainless steel having a thickness of 2 millimetres, an internal diameter of 48 millimetres and a length of 265 millimetres corresponding to a 400 cm² surface. As the anode, a titanium tube of 10 mm external diameter and 1 mm thickness was used, installed in a central position and coaxial with the cathode. The tube was provided with an electrocatalytic coating for oxygen evolution. The prior art suggests the use of coatings of platinum metal, platinum-iridium alloys, oxides of platinum group metals, as such, or preferably added with inert oxides, for example, iridium and tantalum mixed oxide. It is also known that these coatings may be provided with an additional porous layer of inert oxide only, such as, for instance, tantalum oxide, on the outer surface in contact with the solution to be electrolysed. In the course of the testing, several formulations of coated titanium anode were used, as will be specified hereafter.

The cell was also equipped with two nozzles, upper and lower, respectively, for feeding the raw solution at a flow-rate regulated around 400 l/h and for extracting the mixed phase consisting of the electrolysed solution and the hydrogen and oxygen evolved at the cathode and anode, both oriented in the horizontal and tangential direction in order to produce an upward spiral flow inside the cell. A 20 A constant current was applied to the cell, corresponding to a cathodic current density of 500 A/m² and to an anodic current density of 2400 A/m². The voltage was between 4 and 5 volts. During the electrolysis, sulphuric acid was injected with the purpose of restoring the consumed acid and maintaining the pH at the above in indicated value of 1.1.

In the first test, the anode electrocatalytic coating consisted of a commercial formulation of iridium and tantalum mixed oxide in a molar ratio of 1.7:1. The analyses of the hexavalent chromium content indicated an approximately linear decrease in time for a period of about 160 hours with a final concentration of 0.26 g/l (260 ppm), corresponding to an average current efficiency of about 30%. The electrolysis product was essentially trivalent chromium, with just a marginal portion consisting of chromium metal, corresponding to approximately 1-2% of the generated trivalent chromium. By protracting the test, it was observed that the hexavalent chromium content decrease did not follow a linear time dependency any more, indicating the onset of a diffusive type mass transport control. In particular, it was noticed that the hexavalent chromium content decreased to about 0.4 ppm after a further electrolysis period of 10 hours, then remained constant. This result is undoubtedly interesting, being remarkably closer to the 0.05-0.2 ppm limits provided by the applicable norms for industrial waste waters. The reason for the failed further decrease of the hexavalent chromium residual concentration is presumably to be attributed to the capacity of the anode provided with an iridium and tantalum mixed oxide coating to reoxidise, albeit at a low rate, the trivalent chromium generated at the cathode to hexavalent chromium again. Appropriate measurements in fact indicated that the electrochemical potential assumed by the anode was around 1.5 V/SHE, while the minimum potential required to allow the oxidation of trivalent to hexavalent chromium is approximately 1.35-1.4 V/SHE. The fact that the trivalent chromium oxidation potential was lower than the anode working potential indicates, in fact, that oxidation is possible.

With the purpose of diminishing the already satisfactory hexavalent chromium residual concentration, a second and a third test were carried out, making use of the same anode of the first test with the addition of a supplementary tantalum oxide porous coating, totally inert at the electrolysis conditions and capable of acting as a diffusive barrier without sensibly affecting oxygen evolution, and an anode provided with an experimental electrocatalytic coating of iridium and tantalum mixed oxide with the two elements in a molar ratio of 4:1, characterised by a working potential of 1.4 volts, lower than that of commercial type on account of the better electrocatalytic activity for oxygen evolution associated with the higher content of iridium.

The second test showed a decrease in time of the hexavalent chromium concentration equivalent to that of the first test, with a nearly constant final value of 0.3 ppm reached after 180 hours of electrolysis.

An even more interesting result was achieved in the third test, wherein the constant final value of hexavalent chromium residual concentration was placed around 0.15 ppm, thus demonstrating the importance of the catalytic activity level of the anode.

A further proof of the importance of the anode working potential was obtained with a fourth test, in which the cylindrical cell was equipped with a coaxial titanium anode provided with a 5 micron thick pure platinum coating, deposited by a galvanic technique as described in the prior art. In this case it was noticed that the hexavalent chromium concentration decreased with a trend in time substantially similar to that of the previous tests, up to a substantially constant final value of 15 ppm. The anode working potential was centred around 1.7 volts.

### EXAMPLE 2

A fifth test was carried out making use of the circuit of FIG. 2, wherein the operation of the cylindrical cell, configured as in the first test, was arrested after 150 hours at a concentration of hexavalent chromium of about 10 g/l. This solution was reacted in the stirred reactor (18) with a solution containing 50 g/l sodium bisulphite, added in such an amount as to make the redox potential of the solution, measured with probe (21), shift to a value of about 0 V/SHE, corresponding to the presence of a small residue of unreacted free bisulphite. The value of 10 g/l was arbitrarily selected. Nevertheless, protracting the electrolytic treatment up to concentrations comprised between 5 and 25 g/l is particularly advantageous for an ideal coupling with a post-treatment with bisulphite or other chemical reductant. In the indicated conditions, the residual concentration of hexavalent chromium after the post-treatment with bisulphite resulted being 0.05-0-1 ppm, thereby allowing the solution disposal in compliance with the applicable norms. The advantage of the second embodiment of the process of the invention is in the reduction of the operative time of the electrochemical section and in the speed of bringing the solution to minimum levels of hexavalent chromium, with a consequent increase in the treatment capacity for a given equipment size versus the small penalty of a marginal increase in the sulphate concentration, negligible as concerns the above mentioned disposal or crystallisation procedures.

As it will be evident to one skilled in the art, the invention may be practised introducing other variations or modifications to the cited examples. For instance, in the process of the invention the applied current may be decreased as a function of electrolysis time according to a pre-established programme; the cell cathodes may also be provided with a catalytic coating, in this case a coating for hydrogen evolution, for example a chemically or galvanically deposited ruthenium metal coating, whose catalytic activity allows stopping the reduction of hexavalent to trivalent chromium without giving rise to the minor amounts of chromium metal.

Although the disclosure has been shown and described with respect to one or more embodiments and/or implementations, equivalent alterations and/or modifications will occur to others skilled in the art based upon a reading and understanding of this specification. The disclosure is intended to include all such modifications and alterations and is limited only by the scope of the following claims. In addition, while a particular feature may have been disclosed with respect to only one of several embodiments and/or implementations, such feature may be combined with one or more other features of the other embodiments and/or implementations as may be desired and/or advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

1. Process of abatement of the hexavalent chromium content of a raw solution with production of a reduced solution comprising an electrolytic reduction carried out in an electrolysis cell free of a separator provided with inlet and outlet of the raw solution, capable of maintaining a high mass transport through the whole bulk of the cell, and equipped with a stainless steel cathode and an anode suitable for oxygen evolution, wherein said anode is a titanium anode provided with a catalytic coating for oxygen evolution capable of working at a potential lower than 1.7V/SHE.

2. The process of claim 1, the cell having a vertical cylindrical geometry and comprising a cathode constituting an external wall and a cylindrical anode installed in a central position coaxially with the cathode, the inlet and outlet capable of maintaining a high mass transport being respectively placed in correspondence of the lower and upper extremity of the cell with a horizontal and tangential orientation.

3. The process of claim 2, the high mass transport being established by a spiral flow.

4. The process of claim 2, the solution having a flow rate not exceeding 10 m³/h per m² of cathodic surface.

5. The process of claim 1, the electrolytic reduction of hexavalent chromium producing trivalent chromium and chromium metal.

6. The process of claim 1, the stainless steel cathode further comprising a catalytic coating for hydrogen evolution.

7. The process of claim 6, the cathode catalytic coating comprising a ruthenium metal coating.

8. The process of claim 6, the electrolytic reduction of hexavalent chromium producing trivalent chromium only.

9. The process of claim 1, the anode catalytic coating comprising iridium and tantalum mixed oxide.

10. The process of claim 9, the anode catalytic coating having applied thereon an additional porous coating of catalytically inert material.

11. The process of claim 10, additional porous coating comprising tantalum oxide.

12. The process of claim 1, the electrolytic reduction being protracted up to a final concentration of hexavalent chromium not exceeding 0.2 parts per million.

13. The process of claim 1, the electrolytic reduction arrested at a residual concentration of hexavalent chromium in the reduced solution higher than the value prescribed by the norms of disposal of industrial waters and followed by a final treatment of the reduced solution comprising the addition of a chemical reductant.

14. The process of claim 14, the final treatment carried out in a reactor provided with a potentiometric element.

15. The process of claim 15, the final treatment reducing the concentration of hexavalent chromium down to a value not exceeding 0.2 parts per million.

16. The process of claims 14, the reduced solution subjected to the final treatment having a concentration of hexavalent chromium comprised between 5 and 25 g/l.

17. The process claim 14, the chemical reductant comprising one or more of sodium sulphite, sodium bisulphite, ferrous salts, or iron powder.

18. The process of 15, the potentiometric element detecting the redox potential of the reduced solution.

19. The process of claim 18, the chemical reductant comprising sodium bisulphite, and the addition is arrested when the potentiometric element detects a redox potential of about 0 V/SHE.

20. The process of claim 16, the reduced solution being further neutralised with precipitation of trivalent chromium hydroxide, and the chromium hydroxide is subsequently separated by filtration.

21. The process of claim 1, the reduced solution being further evaporated with subsequent separation of trivalent chromium by crystallisation as chromium sulphate.

22. Process of abatement of the hexavalent chromium content of a raw solution with production of a reduced solution comprising an electrolytic reduction carried out in an electrolysis cell free of a separator provided with inlet and outlet of the raw solution, capable of maintaining a high mass transport through the whole bulk of the cell, and equipped with a stainless steel cathode and an anode suitable for oxygen evolution, said cell having a vertical cylindrical geometry and comprising a cathode constituting the external wall and a cylindrical anode installed in a central position coaxially with said cathode, and said inlet and outlet being capable of maintaining a high mass transport being respectively placed in correspondence of the lower and upper extremity of said cell with a horizontal and tangential orientation.
